(19) United States
(12) Patent Application Publication
(10) Pub. No.: US 2013/0061761 A1
(43) Pub. Date: Mar. 14, 2013

(54) BEVERAGE PRODUCTION DEVICE WITH ENHANCED CONTROL MEANS

(71) Applicant: Akos Spiegel, Chavannes-pres-Renens (CH)

(72) Inventor: Akos Spiegel, Chavannes-pres-Renens (CH)

(73) Assignee: NESTEC S.A., Vevey (CH)

(21) Appl. No.: 13/700,053

(22) PCT Filed: May 24, 2011
(86) PCT No.: PCT/EP2011/058458

§ 371 Date: Nov. 26, 2012

(30) Foreign Application Priority Data
May 27, 2010 (EP) 10164137.1

(51) Int. Cl. A47J 31/44

(52) U.S. Cl. 99/285

(57) ABSTRACT

The invention proposes a beverage production device for preparing single-component and/or multi-component beverages comprising: a brewing unit for preparing the component, a user interface (1) providing a plurality of buttons or keys (1a, 1b, 1c) designed for being mechanically operated by a user and having a graphical identification item (3a,3b,3c) associated to the respective button or key (1a, 1b, 1c), a display (2) for displaying information as to the beverages and a plurality of selectable and dynamically allocated functions (5a,5b,5c) by selective pressure on said button or keys (1a, 1b, 1c) of said user interface (1), the display (2) being separated from the user interface (1) and being designed to illustrate a currently set mapping of the respective buttons or keys (1a, 1b, 1c) of the user interface (1) to a selective one of a plurality of functions (5a,5b,5c) by representing the currently set function in close vicinity to a graphical representation (4a,4b,4c) of the respective identification item (3a,3b,3c) of the button or key (1a, 1b, 1c).

### FIELD OF THE INVENTION

The present invention relates to the field of control means for a beverage production device suitable for preparing single-component and/or multi-component beverages. More particularly, the present invention relates to an enhanced user interface for instructing respectively guiding a user during the operation of the beverage production device.

### BACKGROUND OF THE INVENTION

In the field of beverage production devices, a multitude of various systems and devices exist which enable a user of the device to prepare a desired beverage such as e.g. a coffee or coffee-type beverage.

A very known example is the preparation by means of a capsule-respectively cartridge-based system that enables the interaction of liquid such as e.g. water with ingredients provided within the capsule respectively cartridge in order to form a liquid comestible. Thereby, many different types of beverages can be prepared by means of the device such as for example espresso, regular coffee, milk and coffee, milk alone such as e.g. plain or frothed hot milk, cappuccino, tea or other kinds of infusion. However, it may as well be possible to produce other types of liquid comestibles such as e.g. soup with such a device.

US 2007/0243294 for example relates to a method for the preparation of a foamed drink comprising the steps of: providing a capsule containing a foamable ingredient; providing a receptacle positioned to collect fluid escaping from the capsule; injecting liquid into the capsule to mix with the foamable ingredient; allowing the foamable ingredient mixed with the liquid to escape from the capsule into the receptacle; followed by injecting further liquid into the receptacle in a jet having a diameter of from about 0.5 to about 2 mm to produce foamed liquid in the receptacle. The invention also provides capsules, apparatus and systems specifically adapted for use in the method. Preferably, the food ingredient is a milk powder, and the method produces a hot foamed beverage such as a cappuccino coffee.

For the operation of the beverage production device, in general, operation buttons are provided which enable the user to input a desired operating command to the device.

Thereby, it is known to provide operating instructions such as e.g. a user manual that is designed to provide information about how to use the operation buttons of the device in order to activate respectively to trigger a desired operation of the device.

Thereby, the user manual is not only necessary for the first operation of the device until the user is familiar with the operation, but also for rarely occurring operations to be carried out by the device such as e.g.

maintenance and in particular cleaning and/or descaling functions.

In any case, handling of these printed manuals respectively operating instructions becomes very inconvenient in particular if the device to be operated has an increased number of functions to be selected and/or programs to be run by the device. Moreover, the printed operating instructions are easily mislaid and thus, can often not be found by the user when required.

Hence, instruction devices have been developed which provide visual and/or audio information to the user of the device and thus, enable an enhanced guiding of the user through the beverage preparation process respectively through different operational steps to be carried out in order to trigger a desired operation of the device. Thereby, the instruction device is preferably an integral part of the beverage production device.

For example, US 2007/0135948 proposes a device and a method for instructing a user how to operate a domestic appliance such as a coffee machine. The method issues information via at least one output device for instructing the user with regard to the operation of the appliance. The method also identifies a control element of the device, which is to be taken into account by the user during the instruction of the latter by use of at least one marker element.

Moreover, US 2008/183330 proposes a control panel for automatic beverage machines that comprises a touch screen that visually represents icons saved in a memory unit as the displayed basic setting as a first selector mechanism used for choosing a desired beverage and by means of which a predetermined preparation process is triggered. The steps of the selected beverage preparation process may be visually represented on the touch screen. Alternatively, the touch screen is used as a second selector mechanism for choosing a desired preparation setting after a beverage is chosen by actuating the first selector mechanism. When a preparation setting is selected, the touch screen displays the icon for the selected beverage in addition to setting key icons that allow an operator to select and save a desired setting.

It is thus known to provide a dedicated control panel to a beverage production device such that an operator can select a beverage, which in turn is prepared by the device. Thereby, the control panel is preferably coupled with a display device showing the selection as text, symbol or icon, resulting in the possibility for the operator to check his input for selecting a beverage or for an individual setting of preparing a beverage.

It is to be noted that devices for preparing beverages are nowadays adapted to prepare a wide range of different beverages, whereby the user may select out of a plurality of different types of hot beverages and/or may directly adjust beverage parameters or set other operational parameters of the beverage production device.

At the same time, the beverage production devices, in particular for the domestic use, are desired to be of a more and more compacted design in order to save valuable space when being placed on a given support. Accordingly, it is desired to provide control means for such a device that are of particular compact design.

Moreover, enhanced control means are sought-after that enable the selection and setting of a relatively large number of operational parameters of the device and, at the same time, a simple and user-friendly operation of the device. Thereby, it is particularly desirable to reduce the number of provided input elements such as buttons and or keys in order to reduce the complexity of the control means to a minimum.

These objects are solved by means of the features of the independent claim. The dependent claims develop further the central idea of the invention.

### OBJECT AND SUMMARY OF THE INVENTION

The present invention proposes a beverage production device for preparing single-component and/or multi-component beverages comprising: a brewing unit for preparing the component, a user interface providing a plurality of buttons or keys designed for being mechanically operated by a user and having a graphical identification item associated to the respective button or key, a display for displaying information as to the beverages and a plurality of selectable and dynamically allocated functions by selective pressure on said button or keys of said user interface, the display being separated from the user interface and being designed to illustrate a currently set mapping of the respective buttons or keys of the user interface to a selective one of a plurality of functions by representing the currently set function in close vicinity to a graphical representation of the respective identification item of the button or key.

The device according to the present invention is preferably designed to enable the preparation of a plurality of different types of hot and/or cold liquid comestibles such as e.g. coffee, tea, milk, soup of the like. Thereby, the device comprises at least a liquid respectively a water reservoir, heating means such as e.g. a thermoblock, a pump and injection means for providing heated pressurized liquid to a cartridge or capsule selectively insertable in a dedicated extraction chamber of the device. The device thus enables the injection of liquid through a first face of the capsule, after which the liquid is made to interact with ingredients provided within the capsule. By means of the injection of liquid through the capsule, pressure within the capsule is raised, thus leading to the opening of a second face of the capsule from which the liquid comestible can the be poured and collected by a provided receiving vessel such as a cup.

The operations of the device can be controlled by means of the user interface, whereby information relating to the control of the device is output on the display. As the display and the user interface are separated from each other, both the display and the user interface can be independently arranged at the beverage production device.

Accordingly, the size of both the display and the user interface can be reduced and thus, a high adaptability of the display and the user interface to different types of beverage production devices is enabled. Moreover, a convenient provision of the display and the user interface is enabled, particular to beverage production devices of very compact design.

It is to be noted that the user interface is preferably located distantly from the display of the device. Thereby, the user interface and the display of the device are preferably located at different positions and/or parts of the beverage production device. The user interface may for example be located on the top of the device, whereby the display is located on the front of the device.

As the display is adapted to show a currently set mapping of the buttons and/or keys of the user interface, the user of the device is enabled to navigate through the functions illustrated by the display by means of the user interface.

Hereby, since the mapping is obtained by representing the currently set function in close vicinity to a graphical representation of the respective identification item of the button or key, the user is enabled to easily associate the shown functions with the buttons and/or keys of the user interface, whereby at the same time, effective use of the display size for displaying the selectable functions is obtained.

It is to be understood that the graphical representation of the identification items of the buttons or keys is preferably arranged as separate element in close vicinity to the display. Accordingly, the size of the display can be significantly reduced. However, the graphical representation of the identification items may as well be illustrated by the display itself.

The display is preferably an LCD screen. The display may however be any device suitable for illustrating information to a user of the device. For example, the display may as well be an LED or OLED screen.

In addition, the user interface and/or the display may comprise an acoustic output means designed for providing acoustic signals to a user in advance or in response to a command of the user by means of pressing the buttons and/or keys of the user interface.

During the use of the beverage production device, the display provides information regarding the beverage preparation to the user in order to enable a convenient guiding through the beverage preparation process. Thereby, the display preferably provides information regarding the beverages to be prepared, the current process step of the beverage preparation process, the operational state of the device, the current device settings, the functions which can be carried out at each of the different process steps of the beverage preparation process etc. Accordingly, a convenient guidance of the user is enabled and a user manual for operating the device can be omitted.

In a preferred embodiment, the mapping of the displayed functions of the device selectable by a user by means of the keys and/or buttons of the user interface is specifically adapted to the information respectively functions shown on the display.

Moreover, the display is preferably designed to illustrate a currently set mapping for a predefined number of the respective buttons or keys dependent on an operational state of the device.

Accordingly, for each different type of information illustrated by the display, a particular adapted mapping of the selectable functions to the keys and/or buttons of the user interface can be provided.

Moreover, for different kind of information respectively selectable functions shown by the display, different functions are independently assigned to the provided buttons and/or keys of the user interface. It is therefore possible to activated respectively deactivate the keys and/or buttons of the user interface dependent on the operational state of the device for example.

Accordingly, the number of buttons and/or keys of the user interface can be reduced to a minimum.

In a preferred embodiment, the display of the device comprises geographically distinctive functional areas each being designed to display one of a plurality of functions. Thereby, the functions may be any function relating to an operation of the device and/or an operation of the display itself, such as a scroll function through a menu for example.

Preferably, the geographically distinctive functional areas of the display are designed to be independently activated or deactivated. Accordingly, the selectable functions can be individually adapted to the respective information currently illustrated by the display.

In a preferred embodiment, the functional areas are located along at least one side of the display. More preferably, the functional areas are located along the same side of the display. However, the functional areas may as well be located on different sides of the display.

In a preferred embodiment the display comprises at least two, more preferably at least three functional areas. Thereby, preferably at least one functional area is designed to enable a scrolling through the selectable functions of the device. Thereby, the display is preferably designed to illustrate indication means that indicate the current scroll position through a provided function menu of the device.

The graphical representations of the respective identification items of the buttons or keys are preferably present adjacent to the functional areas of the display. Hence, the association of the function shown by the respective functional area of the display to a respective identification item and thus, to a particular button or key of the user interface is facilitated. Accordingly, the handling of the user interface in conjunction with the display is very convenient and easy to use for a user of the device.

It is to be understood that the graphical representations of the identification items are preferably an additional part to the display. Hence, the whole size of the display is useable for the illustration of the respective selectable functions and/or the current operational state of the device. Accordingly, effective use of the display and thus, a reduction of the display size is obtained.

In another preferred embodiment however, the graphical representations of the identification items are an integral part of the display. Accordingly, the assignment of the respective selectable function to a particular graphical representation of the identification item and thus, to a button or key of the user interface is enhanced.

The user interface of the device is preferably a pressure key element providing at least one series of buttons or keys. Thereby, the buttons or keys are to be understood as any mechanical element suitable to sense a motion or an acceleration and thus, to transmit a desired operation of the user to the device.

The keys or buttons of the user interface are preferably arranged in at least one privileged direction, wherein the said direction corresponds to a corresponding privileged direction of the functional areas on the display. Accordingly, the association of the user interface and the functional areas on the display respectively the selectable functions illustrated on the display by said functional areas is enhanced.

In a preferred embodiment, the pressure key element of the user interface comprises respectively left, central and right pressure keys or buttons. In a preferred embodiment, the left and right pressure keys may be keys for scrolling through at least one function menu illustrated by the display of the device, whereby the central key may be for selecting a particular function from the current menu.

However, in another preferred embodiment the pressure key element comprises respectively a left, central, right, top and bottom pressure keys. Accordingly, guiding of the user through a more complex menu structure illustrate by the display is facilitated.

The graphical identification item associated to the respective button or key of the user interface are preferably different for every button or key of the user interface. Thereby, the graphical identification item is preferably a simple geometric figure and/or an alphabetic letter in order to enable the user to recognize a distinct difference between the respective buttons or keys. For example, the graphical identification item may be a geometric circle, a square, a triangle etc. Moreover, the graphical identification may as well be an alphabetic letter like A,B,C,X,Y,Z or the like. However, the graphical identification item may be any kind of symbol enabling to distinguish between the respective buttons or keys.

The buttons or keys may each be of different geometric design in order to further enhance the distinguishability between the buttons or keys.

The graphical identification item is preferably located on a top surface of the respective button or key of the user interface. Thereby, the item is preferably printed on the button or key.

In another preferred embodiment, the buttons or keys are designed to be illuminated by a light source incorporated within the respective button or key of the user interface. Thereby, the button or key respectively the identification item associated to the respective button or key is preferably designed to be independently illuminated. Accordingly, it is possible to indicated to a user of the device which one of the buttons or keys of the user interface is currently activated respectively deactivated.

The graphical representation of the identification items of the button or key is preferably an exact copy regarding size and design of the respective identification item. Accordingly, the association of the button or key to a selectable function displayed in close vicinity of the respective graphical representation of the identification item is facilitated.

In a preferred embodiment, the device comprises a program to display at least one menu for assisting the user to prepare the beverages. Thereby, the device preferably further comprises a memory on which said program is stored.

Moreover, the device preferably includes a microprocessor to run the program stored on the memory of the device.

In another preferred embodiment, transmission means are provided which are connected to the memory of the device and which are designed to connect the device to e.g. an external storage drive or an external network such as for example the Internet or a wireless local area network (WLAN). Accordingly, the information regarding for example the program and/or the information shown by the display and relating to the functions and/or operational parameters and/or to the selectable beverages to be prepared by the device may be changed respectively updated by said transmission means.

The brewing unit of the device is preferably configured for receiving a single-use beverage capsule. Thereby, the term single-use beverage capsule comprises any capsule or cartridge which may individually provided to the device in order to enable an interaction with ingredients provided within the capsule respectively cartridge such that a liquid comestible is formed.

In another preferred embodiment, the menu program of the device is designed for preparing beverages from at least two capsules. Thereby, the at least two capsules preferably comprise different ingredients. It is thus possible to prepare a mixed drink such as for example a cappuccino or latte macchiato drink that can be prepared by means of two different capsules, one containing coffee ingredients and the other containing milk powder.

Thereby, the menu program of the device is preferably designed to illustrate the different steps during the preparation of the drink in a sequential manner. Preferably, the menu program is designed to inform the user when to load and eject the different capsules and to enable the user to input a desired amount of volume of liquid to be injected into each of these capsules.

### BRIEF DESCRIPTION OF THE DRAWINGS

Further features, advantages and objects of the present invention will become apparent for the skilled person when reading the following detailed description of embodiments of the present invention, when taken in conjunction with the figures of the enclosed drawings.

FIG. 1a shows a schematic drawing of a preferred embodiment of a user interface of the beverage production device according to the invention.

FIG. 1b shows a schematic drawing of a preferred embodiment of a display unit of the beverage production device according to the invention.

FIG. 2 shows a perspective top view of a preferred embodiment of a beverage production device having a user interface and separated therefrom the display unit according to the invention.

FIGS. 3-38 show preferred embodiments of the display layout of the display which is designed to illustrate variable selectable functions.

### DETAILED DESCRIPTION OF EMBODIMENTS

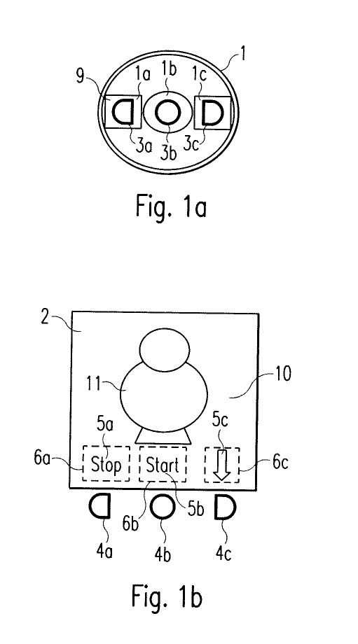

FIG. 1a is a schematic diagram of the user interface 1 of the beverage production device, which enables a user to manually select a desired function of the device. Therefore, the user interface 1 is preferably a pressure key element that comprises at least two, preferably three keys 1a,1b,1c.

The keys 1a,1b,1c may be any mechanical buttons or keys suitable for transmitting a signal to the beverage preparation device in order to trigger a desired operation of the device.

The keys 1a,1b,1c are preferably large enough to enable a convenient operation by means of a finger, in particular by a fingertip or a thumb of a user. Thereby, the keys 1a,1b,1c are preferably of equal size.

However, in another preferred embodiment, the sizes of the keys 1a,1b,1c may vary in order to increase the distinguishability of the respective keys. It may for example be advantageous to have a bigger central key 1b, in particular in an embodiment wherein the respective outer keys 1a,1c, i.e. the keys at the left and right side of the central key 1b, are predominantly used for scrolling through the functions of the menu that are e.g. shown in a dedicated display 2 (c.f. FIG. 1b).

The keys 1a,1b,1c may also be of different geometrical shape as indicated in FIG. 1. In a preferred embodiment, the central key 1b is preferably of circular shape, thus indicating the user that this key is predominantly used for the selection of a function, wherein the outer keys 1a,1c are preferably of triangular or rectangular shape.

The geometrical shape of the central key 1b preferably varies from the geometrical shape of the outer keys 1a,1c. In particular, the outer keys 1a,1c are preferably of equal geometrical shape. However, the keys 1a,1b,1c of the user interface 1 may as well be of any desired geometrical shape.

As shown in FIG. 1a, the keys 1a,1b,1c are preferably equipped with respective identification items 3a,3b,3c. The identification items 1a,1b,1c are preferably different for every key 1a,1b1c. Thereby, the identification items are preferably a simple geometric figure and/or an alphabetic letter.

As shown in the FIG. 1a, at least the central key 1b which may be designed for selecting a desired function of the device from the corresponding menu of the display has an identification item 3b associated to it which differs from the two outer keys 1a,1c. Thereby, the identification item 3b is preferably a circle. The outer identification items 3a,3c may be of similar shape or design. However, as shown in FIG. 1a, the identification items 3a,3c preferably vary such that a user is enabled to distinguish between the respective keys 1a,1b1c.

The identification items 3a,3b,3c are preferably arranged on the respective keys 1a,1b1c. However, the identification items 3a,3b,3c may as well be arranged in close vicinity to the respective keys such that a user is enabled to associate each of the identification items 3a,3b,3c to the corresponding key 1a,1b1c.

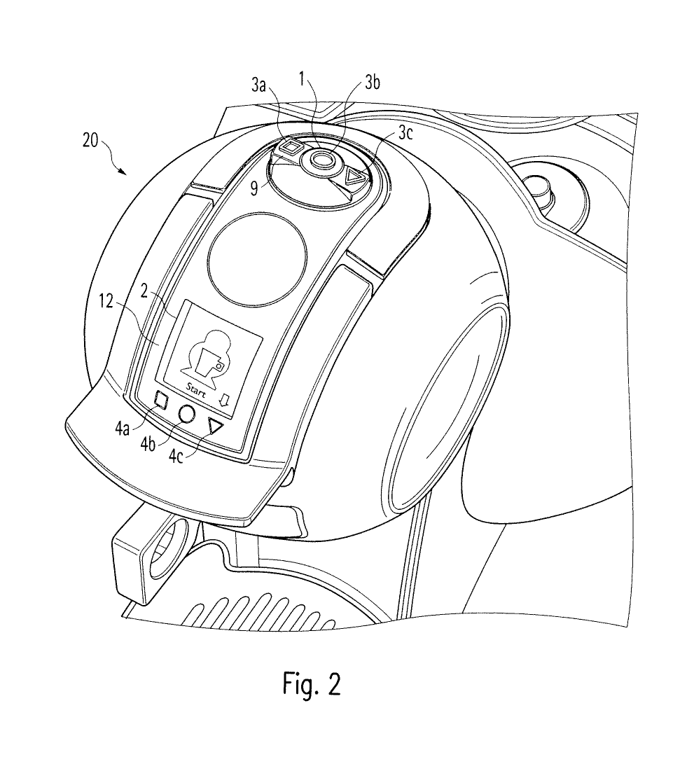

The identification items 3a,3b,3c are preferably protruding from an upper surface 9 of the respective keys 1a,1b,1c (see also FIG. 2). Hence, a user may be enabled to easily identify the respective identification item 3a,3b,3c by touching the upper surface 9 of the respective key 1a,1b1c.

Moreover, the identification items 3a,3b,3c may have illuminating means (not shown) associated to them in order to illuminate the identification items. Thereby, the illuminating means of the identification items 3a,3b,3c may be designed to illuminate only identification items of selectable keys. Accordingly, it may be indicated to a user which one of the respective keys 1a,1b,1c of the user interface is currently selectable and thus activated in the respective menu or operational state of the beverage production device. Thereby, the illuminating means may be for example LEDs placed in close vicinity to the identification items 3a,3b,3c.

FIG. 1b shows a preferred embodiment of the display 2 of the beverage production device according to the present invention. The display 2 is preferably an LCD display designed to illustrate information for instructing the user of the device how to operate the device. The information shown by the display 2 comprises for example different menu structures respectively items for calling up various functions that can be executed by the device upon selection of the user by means of the user interface 1. Thereby, the shown graphical content of the menu structures or selectable functions is preferably retrieve from a storage respectively memory device (not shown) connected to the display 2.

In a preferred embodiment, the display comprises functional areas 6a,6b,6c that are each designed to show different graphical contents. Thereby, the display preferably further comprises a centric information area 10 of bigger size than the functional areas 6a,6b,6c.

The functional areas 6a,6b,6c are preferably designed to illustrate different items or icons resembling to selectable functions of the device. For example, the functional areas 6a,6b,6c may show arrows for scrolling through the operational menu of the device as indicate by shown function 5c. It is to be noted that preferably at least one of the functional areas 6a,6b,6c is designed to illustrate a scrolling function through the menu items of a stored menu program of the device.

Moreover, another functional area 6b may illustrate a starting operation respectively a selection of the chosen menu item 11 such as by displaying a text or a corresponding graphical illustration, e.g. “start”, “GO” or the like, as indicated by shown function 5b.

Another functional area 6a may illustrate a stopping operation respectively a deselection of the respective chosen menu item 11 such as by displaying a text or a corresponding graphical illustration, e.g. “stop”, “go back”, “cancel” or the like, as indicated by shown function 5a.

It is to be noted that the selectable functions 5a,5b,5c are preferably linked to a particular shown menu item 11 which is preferably displayed in the centric information area 10. Accordingly, the information shown by the functional areas 6a,6b,6c are preferably pre-adjusted for each of a given set of menu items 11. However, a user may as well adjust the shown functional areas 6a,6b,6c for any of the menu items 11 independently, e.g. by means of an external input means connectable to the device by means of a dedicate interface.

As shown in FIG. 1b, the functional areas 6a,6b,6c are preferably arranged in a predefined pattern in vicinity of graphical representations 4a,4b,4c of the identification items 3a,3b,3c of keys 1a,1b,1c. Thereby, the functional areas 6a,6b,6c are preferably arranged at an outer side of the display.

Hence, although the display 2 and the user interface 1 are preferably arranged at the beverage production device separate from each other, the user is enabled to easily link any of the functional areas 6a,6b,6c respectively the information shown by the respective functional area to a key of the user interface 1 which is equipped with the corresponding identification items 3a,3b,3c.

Accordingly, an individual mapping of selectable functions 5a,5b,5c of the device shown by the functional areas 6a,6b,6c to the keys 1a,1b,1c of the user interface 1 is enabled and thus, the amount of the provided keys necessary for the operation of the device can be reduced to a minimum.

The functional areas 6a,6b,6c may be activated and/or deactivated depending on the respective menu item of the device. Thereby, the functional areas 6a,6b,6c may be linked to the illumination means of the keys 1a,1b,1c respectively of the identification items 3a,3b,3c of the user interface 1 such that if a functional area 6a,6b,6c is deactivated, the corresponding illumination means of the respective key 1a,1b,1c is also deactivated to indicate to a user that this key is not active for the present menu item selected.

As shown in FIG. 2, the user interface 1 and the display 2 are preferably arranged distantly from each other. Thereby, the display 2 is preferably arranged at a front portion of the beverage production device 20. The user interface 1 is preferably arranged at a top portion of the device 20. Accordingly, both the display 2 and the user interface 1, since being separated form each other, can be designed to be larger in size and thus, enable a convenient operation of the device 20 even if the device is of relatively compact dimensions.

In a preferred embodiment, the graphical representations 4a,4b,4c of the identification items 3a,3b,3c are preferably arranged below the display 2 as indicate in FIG. 2.

In the preferred embodiment according to FIG. 2, the graphical representations 4a, 4b, 4c and thus the identification items 3a,3b,3c are chosen to be different simple geometric figures such as a square, a circle and a triangle. Thus, a user is enabled to easily distinguish between the respective identification items 3a,3b,3c which facilitates the mapping of the functions 5a,5b,5c to the respective keys 1a,1b1c.

The graphical representations 4a,4b,4c may be for example engraved in an upper surface 12 of the beverage production device 20. Moreover, the graphical representations 4a,4b,4c may be equipped with illumination means (not shown) which are preferably designed to be activated respectively deactivated if a corresponding function illustrated by the display 2 respectively by the functional areas 6a,6b,6c is selectable or not.

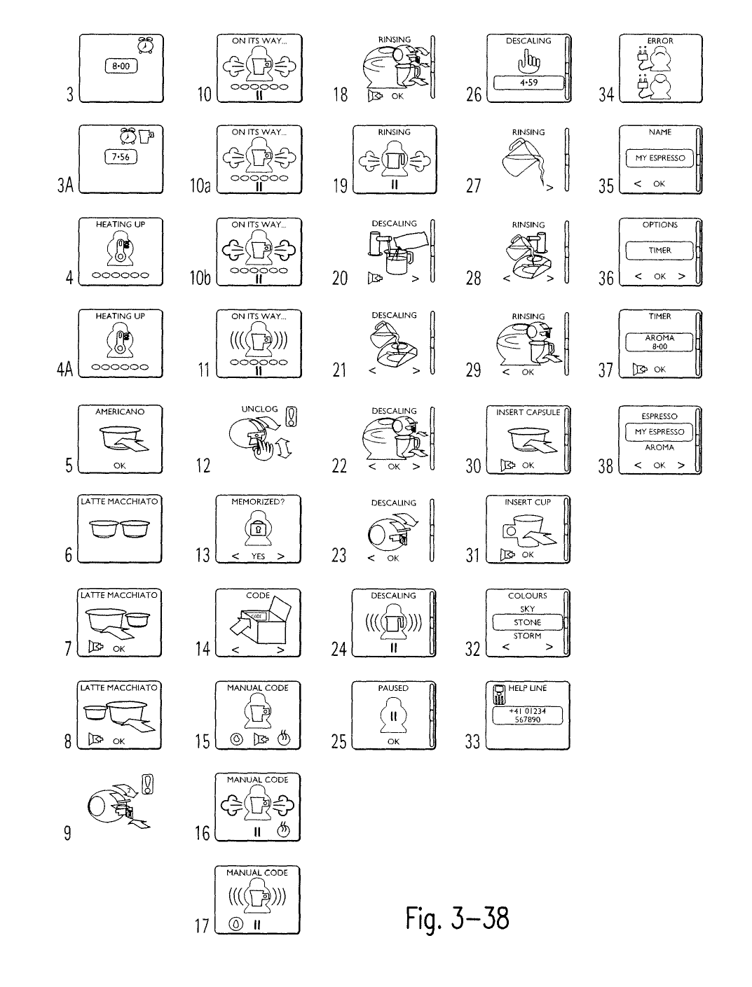

The centric information area 10 preferably shows a current set operational state of the device or a currently selected menu item of a predefined menu of the device. Thereby, the information displayed on the centric information area 10 may be shown by means of text and/or graphical illustration 11 as further indicated by FIGS. 3-38. Thereby, FIGS. 3-38 show exemplary embodiments of the graphical information and/or text illustrated by display 2.

The text and/or graphical illustration 11 may be any information suitable for guiding a user through the beverage preparation steps and/or informing a user about the process or progress of a selected function of the device. Thereby, the information area 10 may for example show a current set time, e.g. when the device is in a stand-by-mode as indicated in FIG. 3,3a.

Moreover, a progress in heating up may be illustrated as indicated e.g. in FIGS. 4,4a.

As indicated in FIGS. 5 to 8, the display may as well illustrate different beverages to be prepared from only one respectively from two different capsules to be provided to the user.

Moreover, a user may be instructed to descale the device as shown by FIGS. 20 to 23. Thereby, the information area 10 may show the subsequential steps which have to be carried out by the user for a successful descaling of the device.

In addition, a rinsing process of the device may be shown and explained to the user step by step by means of the information area 10 as indicated in FIGS. 27 to 29.

For all of the shown different menu items 11 shown by the information area 10, the mapping of the adjustable functions 5a,5b,5c to the keys 1a,1b,1c is preferably adjusted. Hence, for each of the menu items 11, different selectable functions 5a,5b,5c may be defined. Accordingly, the keys 1a,1b,1c are given different functions depending on the current set menu item 11.

The mapping of the selectable functions 5a,5b,5c to the respective keys 1a,1b,1c is preferably saved in the memory device of the beverage production device. Preferably, only one key 1a,1b,1c is assigned respectively mapped to a selectable function of a current menu item 11. However, even more than one key 1a,1b,1c may be assigned to the same selectable function in order to facilitate the input by the user.

Besides preset functions of the beverage preparation device which can be chosen by the consumer by pressing a corresponding key 1a,1b,1c of the user interface mapped to the selectable function shown by means of the functional areas 6a,6b,6c, the user may as well manually input a specific operation to the device by means of the respective keys. Thereby, the keys 1a,1b,1c and/or the menu program is preferably designed to sense an amount of time for which the respective key has been pushed down by the user.

Accordingly, a user may for example choose a particular amount of liquid to be provided to a capsule by holding the respective key for as long as he whishes in order to set a desired volume of the beverage to be prepared. Thereby, the menu program of the device is preferably designed to memorize such a manual input of the user and output a corresponding information 11 to the user as for example indicated in FIG. 13, thereby asking if the input is to be saved on the memory.

The menu program of the device is preferably further designed to memorize the most selected functions chosen by a user. Thereby, the program may be designed to adjust the mapping of the selectable functions 5a,5b,5c dependent on the occurrence respectively on how often the selective function has been chosen by a user. This may for example be memorized and/or adjusted for each menu item and the corresponding selectable functions individually. Thereby, specific patterns of selections of the user may be saved for different beverage preparation processes. Moreover, the menu items 11 and/or the selectable functions 5a,5b,5c may be displayed in the display 2 in a way that the most selected menu items 11 and/or the most selected functions are listed first.

Although the present invention has been described with reference to preferred embodiments thereof, many modifications and alternations may be made by a person having ordinary skill in the art without departing from the scope of this invention which is defined by the appended claims.

1-18. (canceled)

19. Beverage production device for preparing single-component and/or multi-component beverages comprising:
a brewing unit for preparing the component,
a user interface comprising a plurality of buttons or keys designed for being mechanically operated by a user and having a graphical identification item associated with the respective button or key;
a display for displaying information as to the beverages and a plurality of selectable and dynamically allocated functions by selective pressure on the button or keys of the user interface; and
the display being separated from the user interface and being designed to illustrate a currently set mapping of the respective buttons or keys of the user interface to a selective one of a plurality of functions by representing the currently set function in close vicinity to a graphical representation of the respective identification item of the button or key.

20. Beverage production device according to claim 19,
wherein the display is designed to illustrate a currently set mapping for a predefined number of the respective buttons or keys dependent on an operational state of the device.

21. Beverage production device according to claim 19,
wherein the display comprises geographically distinctive functional areas each being designed to display one of a plurality of functions.

22. Beverage production device according to claim 21,
wherein the geographically distinctive functional areas are designed to be independently activated or deactivated.

23. Beverage production device according to claim 21, wherein the functional areas are located along at least one side of the display.

24. Beverage production device according to claim 19, wherein the graphical representations of the respective identification items of the buttons or keys are adjacent to the functional areas of the display.

25. Beverage production device according to claim 24, wherein the graphical representations are an integral part of the display.

26. Beverage production device according to claim 19, wherein the user interface is distantly located from the display.

27. Beverage production device according to claim 21, wherein the user interface is a pressure key element providing at least one series of buttons or keys in at least one direction, the direction corresponding to a corresponding direction of the functional areas on the display.

28. Beverage production device according to claim 27, wherein the pressure key element comprises respectively left, central and right pressure keys.

29. Beverage production device according to claim 27, wherein the pressure key element comprises respectively a left, central, right, top and bottom pressure keys.

30. Beverage production device according to claim 19, wherein the user interface is located on the top of the device and the display is located on the front of the device.

31. Beverage production device according to claim 19, wherein the device comprises a program to display at least one menu for assisting the user to prepare the beverages.

32. Beverage production device according to claim 21, wherein at least one functional area is a scrolling function of the menu.

33. Beverage production device according to claim 24, wherein the graphical representations are provided as an additional part to the display.
